(19) United States
(12) Patent Application Publication
(10) Pub. No.: US 2014/0140798 A1
(43) Pub. Date: May 22, 2014

(54) CONVEYOR AND HOIST FOR AIR SEEDERS

(71) Applicant: Leon Dekoning, Hayter (CA)

(72) Inventor: Leon Dekoning, Hayter (CA)

(21) Appl. No.: 13/735,147

(22) Filed: Jan. 7, 2013

(30) Foreign Application Priority Data
Nov. 21, 2012 (CA) 2796772

(51) Int. Cl. A01C 15/00

(52) U.S. Cl. CPC A01C 15/003; A01C 15/006
USPC 414/523; 414/812

(57) ABSTRACT

A conveyor and hoist apparatus for filling air seeder tanks has a vertical post and a telescoping hoist arm pivotally attached to a top end of the post. A hook hangs down from an outside end of the hoist arm and is pivotally attached thereto about a vertical and horizontal hook pivot axes. A conveyor rest supports a conveyor in a transport position wherein the post is between the conveyor and the tanks The hook engages a lift bar on top of the conveyor near the center of gravity thereof. An operator can manipulate the arm to move the conveyor from the transport position to an operating position with the intake end thereof is on the ground and a discharge end pointed into one of the tanks, or engage the hook member with a bag tether to raise a bag above the tanks to drain the contents into the tanks.

This invention is in the field of agricultural air seeder implements and in particular a conveyor and hoist apparatus for the product tanks of air seeders.

### CROSS-REFERENCE TO RELATED APPLICATIONS

This application claims priority to Canadian Patent Application No. 2,796,772, filed on Nov. 21, 2012, the entire contents of which are hereby incorporated by reference.

### BACKGROUND

Agricultural air seeder implements have a plurality of furrow openers mounted on an implement frame, and a number of tanks for carrying agricultural products. Typically the tanks are carried on a cart pulled either behind or ahead of the implement frame although it is also known to mount the tanks directly on the implement frame. Typically, a conveyor with an intake hopper is mounted on the air seeder for receiving agricultural product from a transport vehicle and transferring it into the tanks The agricultural product tanks on present day air seeders are quite large, and product capacities of 800 to 1000 bushels or more are common.

The conveyors have therefore become quite large in order to reduce the time spent filling and maximize operating time. Such an air seeder conveyor is disclosed for example in U.S. Pat. No. 7,267,519 to Cresswell. U.S. Pat. No. 6,805,229 to Dekoning also discloses a telescoping belt conveyor that is often used as a conveyor on an air seeder where added range for the intake end of the conveyor is desired.

Air seeder conveyors are commonly mounted on a pivot mechanism configured to allow it to be moved from a transport position, where the bottom end of the conveyor is raised for transport, to an operating position where the bottom end is lowered to receive agricultural material from the transport vehicle, typically resting on the ground. The pivot is located at a location on the conveyor such that the conveyor is substantially balanced, reducing the lifting effort required by the operator to lift the intake end from the ground to the raised transport position. The conveyor must also be maneuvered by the operator carrying the intake end so that the spout on the upper discharge end of the conveyor directs agricultural product from the conveyor into a desired one of the filling hatches opening into each of the tanks

As these conveyor have grown larger, they have become heavier and more difficult to maneuver. The pivot mounting system typically is configured so that the intake end always has weight on it and tends downward in order to prevent the discharge end of the conveyor from tipping down. Further, with a telescoping conveyor such as that of Dekoning, the balance point changes as the intake end of the conveyor moves in and out, and so the manual lift required can be significant. To address this problem, U.S. Pat. No. 7,500,814 to Meyer discloses a conveyor positioning system for an air cart which moves the conveyor with hydraulic cylinders.

Since most agricultural products are carried in bulk, the conveyor is convenient for transferring the bulk product. It is however not uncommon for some agricultural products, typically those where lower quantities are used or where the products are more costly, to be handled in bags. The bags can be small bags about 50 pounds in weight that are handled manually, or large “mini-bulk” bags of about 1500 pounds or more that can only be handled with mechanical loaders, hoists, and the like.

Either type of bag must typically be raised to the filling hatches on top of the product tanks and emptied into the tank. Small bags can simply be carried to the top manually however this can be an onerous chore, and so it is common to empty the bags into the conveyor intake. Also United States Patent Application Number 2006/0120836 of Cresswell addresses the problem by providing a platform on a hoist for raising bags of agricultural products to the top filling hatches.

When using large mini-bulk bags, typically it is necessary to bring a loader to each filling location to lift the bag off the transport vehicle for loading into the product tanks, complicating the filling process and adding extra costs. The typical farm loader cannot often raise the bag high enough to drain the product directly from the bag into the filling hatch, and so again it is common to simply drain the product from the bag into the conveyor intake. Canadian Patent Application Number 2,416,677 of Hundeby addresses the problem by providing a hoist mounted on the air seeder cart and having sufficient power and reach to raise the bag above the filling hatch so product can be drained directly into the hatch.

### SUMMARY OF THE INVENTION

It is an object of the present invention to provide a conveyor and hoist apparatus for an air seeder that overcomes problems in the prior art.

In a first embodiment the present invention provides a conveyor and hoist apparatus for filling product tanks mounted on a frame of an air seeder, the frame mounted on wheels for movement in an operating travel direction. The apparatus comprises a substantially vertically oriented pivot post mounted to the frame adjacent to the product tanks, and a telescoping hoist arm pivotally attached at an inside end thereof to a top end of the pivot post about a substantially vertical arm pivot axis, and about a substantially horizontal arm pivot axis. An arm extension actuator is operative to extend and retract the hoist arm, and an arm lift actuator is operative pivot the hoist arm up and down about the horizontal arm pivot axis. A hook member hangs down from an outside end of the hoist arm and is pivotally attached to the outside end of the hoist arm about a substantially vertical hook pivot axis and a substantially horizontal hook pivot axis. A conveyor rest is attached to the frame and is operative to support a conveyor in a transport position wherein a longitudinal axis of the conveyor is substantially aligned with an operating travel direction of the air seeder, and the pivot post is between the conveyor and the product tanks A lift bar is attached to the conveyor above the conveyor and in proximity to a center of gravity of the conveyor, and the hook member is adapted to releasably engage the lift bar about a substantially horizontal conveyor pivot axis oriented perpendicular to a longitudinal axis of the conveyor to raise the conveyor above the rest. The pivot post and hoist arm are configured to allow an operator to move the conveyor from the transport position to an operating position where the intake end thereof is on the ground and a discharge end thereof is oriented to discharge into one of the product tanks, and the pivot post and hoist arm are also configured to allow an operator to engage the hook member with a bag tether to raise a bag of agricultural products above at least one of the product tanks such that contents of the bag can be drained into the at least one of the product tanks

In a second embodiment the present invention provides a method of transferring agricultural products into product tanks mounted on a frame of an air seeder, the frame mounted on wheels for movement in an operating travel direction. The method comprises mounting a pivot post to the frame adjacent to the product tanks; pivotally mounting a telescoping hoist arm on a top end of the pivot post about a substantially vertical arm pivot axis, and about a substantially horizontal arm pivot axis, with an arm lift actuator operative pivot the hoist arm up and down about the horizontal arm pivot axis; pivotally mounting a hook member to an outside end of the hoist arm about a substantially vertical hook pivot axis and a substantially horizontal hook pivot axis; supporting a conveyor on a conveyor rest in a transport position such that a longitudinal axis of the conveyor is substantially aligned with an operating travel direction of the air seeder, and the pivot post is between the conveyor and the product tanks; mounting a lift bar to the conveyor above the conveyor and in proximity to a center of gravity of the conveyor; where the agricultural products are transported in bulk in a transport vehicle, engaging the hook member with the lift bar about a substantially horizontal conveyor pivot axis oriented perpendicular to a longitudinal axis of the conveyor and activating the arm lift actuator to raise the conveyor above the conveyor rest and maneuvering the conveyor from the transport position to an operating position where the intake end thereof is on the ground and a discharge end thereof is oriented to discharge into one of the product tanks and directing agricultural products from the transport vehicle into the intake end of the conveyor and operating the conveyor to discharge the agricultural products into the one of the product tanks; and where the agricultural products are transported in a bag, engaging the hook member with a bag tether to raise the bag above a desired one of the product tanks and draining the agricultural products from the bag into the desired one of the product tanks.

The present invention provides a conveyor and hoist apparatus that conveniently transfers bagged agricultural products into the product tanks without the need to have a separate loader vehicle at the fill site, and also conveniently transfers bulk agricultural products from a transport vehicle into the product tanks with the conveyor. The conveyor, whether conventional or telescoping, is readily maneuvered to discharge into any of the product tanks, and also to the transport position supported on the conveyor rest.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the conveyor and hoist apparatus of the present invention, with the conveyor in the transport position supported on the conveyor rest;

FIG. 2 is a schematic side view of the embodiment of FIG. 1 with the conveyor partially raised off the conveyor rest;

FIG. 3 is a schematic side view of the embodiment of FIG. 1 with the conveyor in the operating position, with a transport vehicle directing agricultural products into the intake end of the conveyor;

FIG. 4 is a schematic side view of the embodiment of FIG. 1 with the conveyor in the transport position and with the hoist arm picking a bag off agricultural products off the ground and raising the bag above the product tanks to drain the contents into one of the tanks;

FIG. 5 is a schematic side view of the outside end of the hoist arm with the hook member engaging the lift bar of the conveyor, and also showing a connectors for a hydraulic motor driving the conveyor;

FIG. 6 is a schematic front view of the outside end of the hoist arm with the hook member engaging the lift bar of the conveyor as in the side view of FIG. 5;

FIG. 7 is a schematic top view of a lift bar location adjustment mechanism for a telescoping conveyor to maintain the desired position of the lift bar relative to the center of gravity of the conveyor as same extends and retracts;

FIG. 8 is a schematic side view of the telescoping conveyor and lift bar location adjustment mechanism of FIG. 7 moving from a retracted to an extended position;

FIG. 9 is a schematic top view of the embodiment of FIG. 1 with the conveyor in the transport position; and

FIG. 10 is a schematic top view of the embodiment of FIG. 1 with the conveyor in the operating position.

### DETAILED DESCRIPTION OF THE ILLUSTRATED EMBODIMENTS

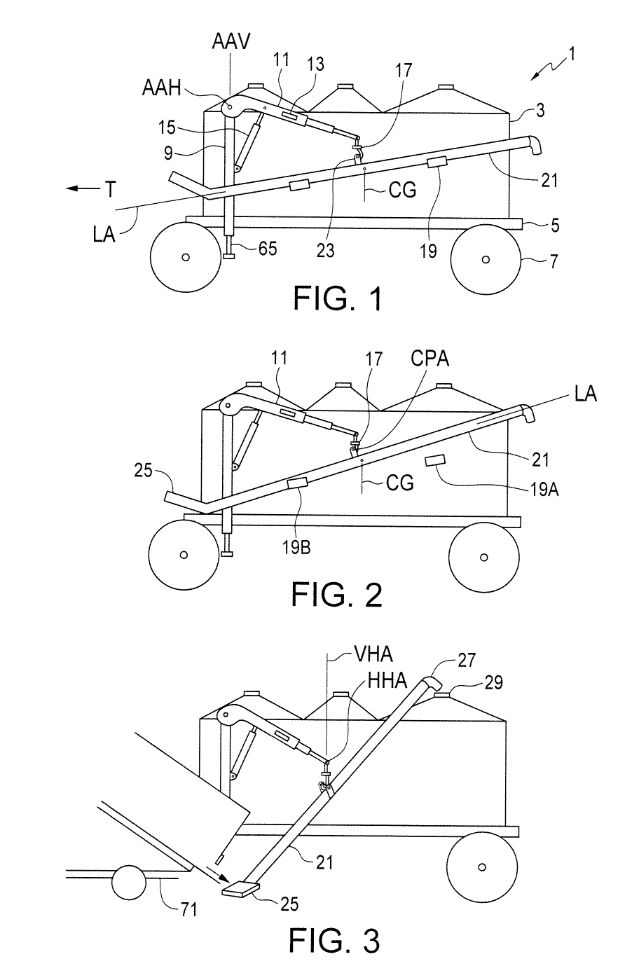

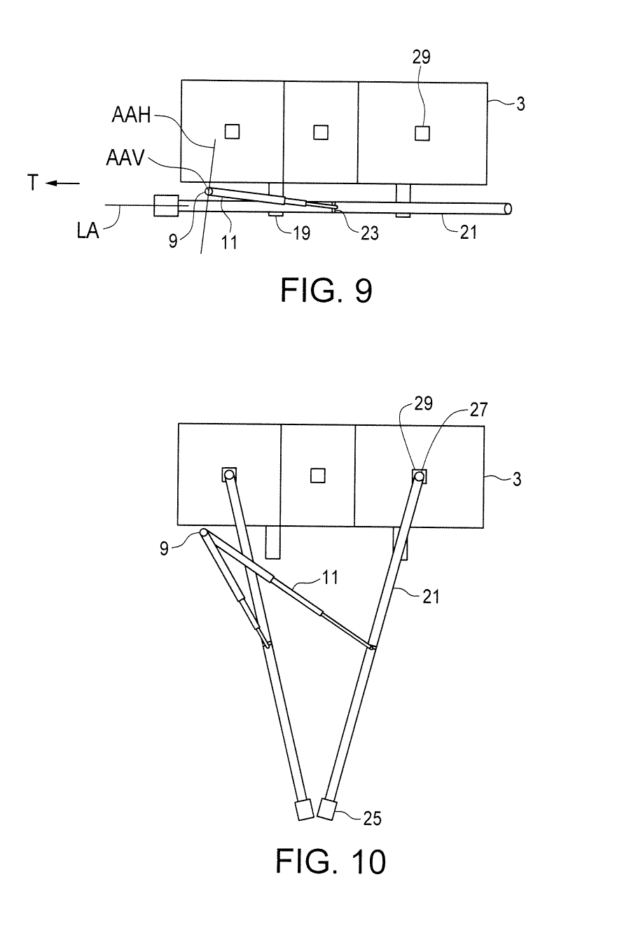

FIGS. 1-4 schematically illustrate an embodiment of a conveyor and hoist apparatus 1 of the present invention for filling product tanks 3 mounted on a frame 5 of an air seeder that is mounted on wheels 7 for movement in an operating travel direction. The product tanks 3 can be mounted on the frame 5 of a cart pulled behind or in front of the ground working implement as shown in FIG. 1, or on the frame of the ground working implement itself. FIGS. 9 and 10 schematically illustrate a top view of the apparatus 1.

The apparatus 1 comprises a substantially vertically oriented pivot post 9 mounted to the frame 5 adjacent to the product tanks 3, and a telescoping hoist arm 11 pivotally attached at an inside end thereof to a top end of the pivot post 9 about a vertical arm pivot axis AAV, and about a horizontal arm pivot axis AAH that is oriented substantially perpendicular to the arm 11. An arm extension actuator 13, typically a series of hydraulic cylinders, is operative to extend and retract the hoist arm 11, and an arm lift actuator 15, typically a hydraulic cylinder, is operative pivot the hoist arm 11 up and down about the horizontal arm pivot axis AAH.

A hook member 17 hangs down from an outside end of the hoist arm 11 and is pivotally attached to the outside end of the hoist arm 11 about a vertical hook pivot axis HAV and a horizontal hook pivot axis HAH, as schematically illustrated in FIGS. 5 and 6. To facilitate movement of heavy loads on the hook member, a motor 18, such as a hydraulic motor, can be mounted between the hook member 17 and the outside end of the hoist arm 11 to rotate the hook member 17 about the vertical hook pivot axis HAV.

Conveniently the arm extension actuator 13, arm lift actuator 15, and motor 18 will be controlled with a wireless remote control 20.

A conveyor rest 19 is attached to the frame 5 directly or through attachment to the product tanks 3, and is operative to support a conveyor 21 in a transport position as illustrated in FIGS. 1 and 9 where a longitudinal axis LA of the conveyor 21 is generally aligned with an operating travel direction T of the air seeder, and the pivot post 9 is between the conveyor 21 and the product tanks 3, as best seen in FIGS. 9 and 10. The pivot post 9 is mounted in proximity to one end of the frame 5, and, when the conveyor 21 is in the transport position, the intake end 25 thereof is in proximity to the end of the frame 5 near the pivot post 9, and the conveyor 21 extends toward the opposite end of the frame 5.

A lift bar 23 is attached to the conveyor 21 above the conveyor and in proximity to a center of gravity CG of the conveyor 21, and the hook member 17 is adapted to releasably engage the lift bar 21 about a substantially horizontal conveyor pivot axis CPA oriented perpendicular to a longitudinal axis LA of the conveyor to raise the conveyor 21 above the rest 19 when the arm lift actuator 15 is extended. If the lift bar 23 is exactly on the center of gravity CG, the conveyor 21 will balance when the lift bar 23 is moved upward. It is generally desirable to have the lift bar 23 located toward the discharge end 25 of the conveyor 21 from the center of gravity CG so that when the lift bar 23 is moved upward, the intake end 25 moves downward in response to gravity.

The illustrated lift bar 23 is so oriented, as can be seen in FIG. 2 where the lift bar 23 has been moved upwards a short distance and the conveyor 21 is raised off the upper rest 19A but continues to rest on the lower rest 19B. This orientation leaves sufficient weight on the discharge end 25 so that that end stays on the ground where it is wanted, but the weight on the intake end is minimal and readily borne by an operator, so that the operator can easily raise the intake end 25 off the lower rest 19B, and maneuver the conveyor. The pivot post 9 and hoist arm 11 are configured to allow the operator to move the conveyor 21 from the transport position of FIGS. 1 and 9 to the operating position of FIGS. 3 and 10 where the intake end 25 of the conveyor 21 is on the ground and the discharge end 27 thereof is oriented to discharge into one of the product tanks 3 through the fill hatch 29 thereof. As seen in FIG. 10 the discharge end 27 of the conveyor 21 can be maneuvered to discharge into fill hatches 29 of the various product tanks 3.

As illustrated in FIGS. 5 and 6, the lift bar 23 is cylindrical with an outside surface corresponding to an inside surface of a hook recess 35 of the hook member 17 such that the lift bar 23 rotates in the hook recess 35 to provide the conveyor pivot axis CPA. The lift bar 23 is oriented substantially perpendicular to a longitudinal axis LA of the conveyor 21, and the lift bar 23 engages the hook recess 35 along a length L of the lift bar 23 that is sufficient to substantially prevent the conveyor 21 from rotating about the longitudinal axis LA thereof.

The conveyor 21 can be powered by various motors however it is convenient to use a hydraulic motor 37. The source hydraulic conduits 39 carrying pressurized hydraulic fluid are attached along the telescoping hoist arm 11 and terminate in proximity to the outside end of the hoist arm 11 at a source connector assembly 41. Motor hydraulic conduits 43 connect the hydraulic motor 37 to a motor connector assembly 45 configured to connect to the source connector assembly 41 by a quick connect mechanism as is known in the art.

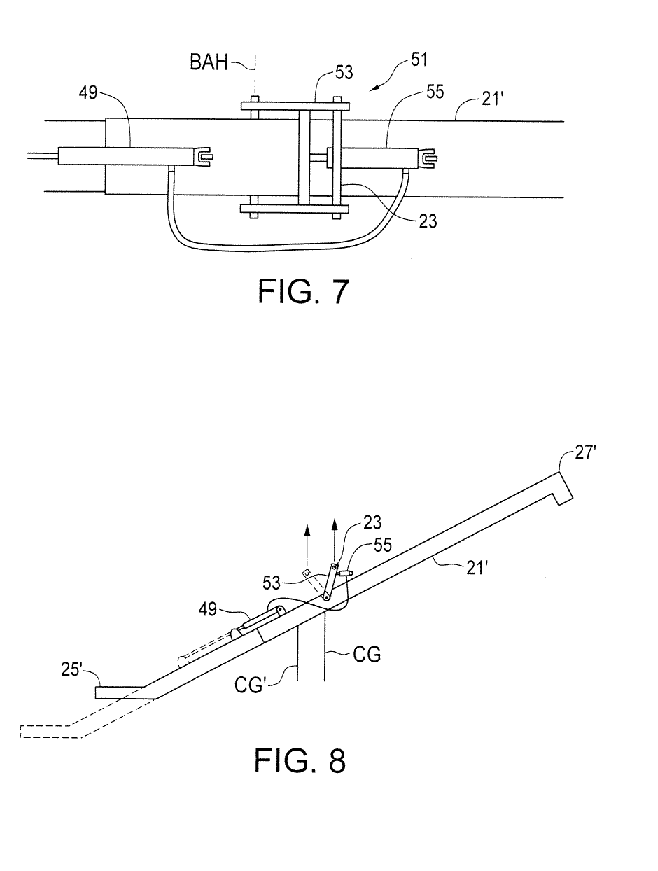

It is known to use a telescoping conveyor 21′ for filling the product tanks of an air seeder, such as schematically illustrated in FIGS. 7 and 8, with a telescoping actuator 49 operative to extend and retract the conveyor 21′ as in FIG. 8. To accommodate the telescoping conveyor 21′, a lift bar location adjustment mechanism 51 is provided to move the lift bar 23 as required to maintain a desired location with respect to the center of gravity CG as the conveyor 21′ extends and retracts.

The illustrated lift bar location adjustment mechanism 51 comprises a lift bar bracket 53 pivotally attached at a lower portion thereof to the conveyor 21′ about a substantially horizontal bracket axis BAH oriented substantially perpendicular to the longitudinal axis LA of the conveyor 21′, and a lift bar actuator 55 operative to pivot the lift bar bracket 53 about the bracket axis BAH. The lift bar 23 is attached to an upper portion of the lift bar bracket 53, and upward raising forces are exerted on 5the lift bar 23.

As illustrated in FIG. 8, when the conveyor 21′ is retracted, the center of gravity thereof is located at CG, and the lift bar 23 is located toward the discharge end 27′ of the conveyor 21′ so that the intake end 25′ moves downward. As the conveyor 21′ extends as indicated by the dotted lines, the center of gravity shifts to location CG′, and the lift bar actuator 55 moves the lift bar bracket 53 to maintain the general relationship of the lift bar 23 and the center of gravity so that excess weight is not placed on the intake end 25′, making same difficult for an operator to lift and maneuver.

Conveniently the telescoping actuator 49 and the lift bar actuator 55 are connected such that as the telescoping actuator 49 extends and retracts the conveyor 21′, the lift bar actuator automatically pivots the lift bar bracket 53 about the bracket axis BAH to substantially maintain the desired location of the lift bar 23 with respect to the center of gravity CG, CG′. The telescoping actuator 49 and the lift bar actuator 55 are provided respectively by a telescoping hydraulic cylinder and a lift bar hydraulic cylinder, and when the telescoping hydraulic cylinder extends and retracts, hydraulic fluid flows between the telescoping hydraulic cylinder and the lift bar hydraulic cylinder to correspondingly extend and retract the lift bar hydraulic cylinder and move the lift bar 23.

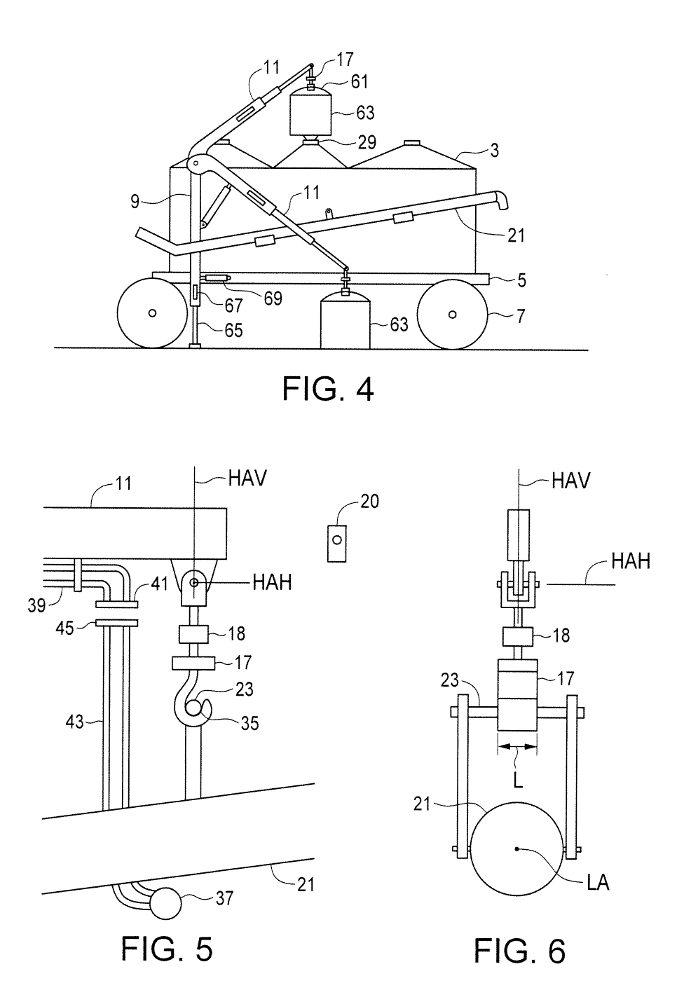

As illustrated in FIG. 4, the pivot post 9 and hoist arm 11 are also configured to allow an operator to engage the hook member 17 with a bag tether 61 to raise a bag 63 of agricultural products above one of the product tanks 3 such that contents of the bag 63 can be drained into the product tank 3 through the fill hatch 29 thereof.

A support leg 65 is mounted to the frame 5 in proximity to the pivot post 9, and a leg actuator 67 is operative to move the support leg 65 from a raised transport position, as shown in FIG. 1 where a bottom end of the support leg is above the ground, to the lowered operating position illustrated in FIG. 4 where the bottom of the support leg 65 bears against the ground to support the frame 5 when lifting a heavy bag 63. An arm lateral actuator 69 can be provided to pivot the hoist arm 11 laterally right and left about the vertical arm pivot axis AAV to aid in maneuvering the conveyor 21 and heavy bags.

The invention further provides a method of transferring agricultural products into product tanks 3 mounted on a frame 5 of an air seeder, the frame 5 mounted on wheels 7 for movement in an operating travel direction T. The method comprises mounting a pivot post 9 to the frame 5 adjacent to the product tanks 3; pivotally mounting a telescoping hoist arm 11 on a top end of the pivot post 9 about a about a substantially vertical arm pivot axis AAV, and about a substantially horizontal arm pivot axis AAH, with an arm lift actuator 15 operative pivot the hoist arm 11 up and down about the horizontal arm pivot axis AAH; pivotally mounting a hook member 17 to an outside end of the hoist arm 11 about a substantially vertical hook pivot axis VHA and a substantially horizontal hook pivot axis HHA; supporting a conveyor 21 on a conveyor rest 19 in a transport position such that a longitudinal axis LA of the conveyor 21 is substantially aligned with an operating travel direction T of the air seeder, and the pivot post 9 is between the conveyor 21 and the product tanks 3; mounting a lift bar 23 to the conveyor 21 above the conveyor and in proximity to a center of gravity CG of the conveyor 21; where the agricultural products are transported in bulk in a transport vehicle 71 as seen in FIG. 3, engaging the hook member 17 with the lift bar 23 about a substantially horizontal conveyor pivot axis CPA oriented perpendicular to a longitudinal axis LA of the conveyor 21 and activating the arm lift actuator 15 to raise the conveyor 21 above the conveyor rest 19 and maneuvering the conveyor 21 from the transport position to an operating position where the intake end 25 thereof is on the ground and the discharge end 27 thereof is oriented to discharge into one of the product tanks 3 and directing agricultural products from the transport vehicle 71 into the intake end 25 of the conveyor 21 and operating the conveyor 21 to discharge the agricultural products into the one of the product tanks 3; and where the agricultural products are transported in a bag 63, engaging the hook member 17 with a bag tether 61 to raise the bag 63 above a desired one of the product tanks 3 and draining the agricultural products from the bag 63 into the desired one of the product tanks 3, as schematically illustrated in FIG. 4.

The present invention thus provides a conveyor and hoist apparatus that conveniently transfers agricultural products that are either bulk or bagged from a transport vehicle into the product tanks The conveyor, whether conventional or telescoping, is readily maneuvered to discharge into any of the product tanks, and also to the transport position supported on the conveyor rest.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A conveyor and hoist apparatus for filling product tanks mounted on a frame of an air seeder, the frame mounted on wheels for movement in an operating travel direction, the apparatus comprising:
a substantially vertically oriented pivot post mounted to the frame adjacent to the product tanks;
a telescoping hoist arm pivotally attached at an inside end thereof to a top end of the pivot post about a substantially vertical arm pivot axis, and about a substantially horizontal arm pivot axis;
an arm extension actuator operative to extend and retract the hoist arm;
an arm lift actuator operative pivot the hoist arm up and down about the horizontal arm pivot axis;
a hook member hanging down from an outside end of the hoist arm and pivotally attached to the outside end of the hoist arm about a substantially vertical hook pivot axis and a substantially horizontal hook pivot axis;
a conveyor rest attached to the frame and operative to support a conveyor in a transport position wherein a longitudinal axis of the conveyor is substantially aligned with an operating travel direction of the air seeder, and the pivot post is between the conveyor and the product tanks;
a lift bar attached to the conveyor above the conveyor and in proximity to a center of gravity of the conveyor;
wherein the hook member is adapted to releasably engage the lift bar about a substantially horizontal conveyor pivot axis oriented perpendicular to a longitudinal axis of the conveyor to raise the conveyor above the rest;
wherein the pivot post and hoist arm are configured to allow an operator to move the conveyor from the transport position to an operating position where the intake end thereof is on the ground and a discharge end thereof is oriented to discharge into one of the product tanks; and
wherein the pivot post and hoist arm are configured to allow the operator to engage the hook member with a bag tether to raise a bag of agricultural products above at least one of the product tanks such that contents of the bag can be drained into the at least one of the product tanks.

2. The apparatus of claim 1 wherein, with respect to the center of gravity of the conveyor, the lift bar is located toward the discharge end of the conveyor such that when the lift bar is moved upward, the intake end moves downward in response to gravity.

3. The apparatus of claim 2 a weight of the intake end can be borne by an operator to maneuver the conveyor.

4. The apparatus of claim 1 wherein the lift bar is substantially cylindrical with an outside surface substantially corresponding to an inside surface of a hook recess of the hook member such that the lift bar rotates in the hook recess to provide the conveyor pivot axis.

5. The apparatus of claim 4 wherein the lift bar is oriented substantially perpendicular to a longitudinal axis of the conveyor, and wherein the lift bar engages the hook recess along a length of the lift bar sufficient to substantially prevent the conveyor from rotating about the longitudinal axis thereof.

6. The apparatus of claim 1 wherein the conveyor is driven by a hydraulic motor, and wherein source hydraulic conduits carrying pressurized hydraulic fluid are attached along the telescoping hoist arm and terminate in proximity to the outside end of the hoist arm at a source connector assembly, and wherein motor hydraulic conduits connect the hydraulic motor to a motor connector assembly configured to connect to the source connector assembly.

7. The apparatus of claim 1 wherein the pivot post is mounted in proximity to a first end of the frame, and wherein, when the conveyor is in the transport position, the intake end thereof is in proximity to the first end of the frame and the conveyor extends toward an opposite second end of the frame.

8. The apparatus of claim 1 wherein the conveyor is a telescoping conveyor with a telescoping actuator operative to extend and retract the conveyor, and further comprising a lift bar location adjustment mechanism operative to move the lift bar to substantially maintain a desired location with respect to the center of gravity as the conveyor extends and retracts.

9. The apparatus of claim 8 wherein the lift bar location adjustment mechanism comprises a lift bar bracket pivotally attached at a lower portion thereof to the conveyor about a substantially horizontal bracket axis oriented substantially perpendicular to the longitudinal axis of the conveyor, and a lift bar actuator operative to pivot the lift bar bracket about the bracket axis, and wherein the lift bar is attached to an upper portion of the lift bar bracket.

10. The apparatus of claim 9 wherein the telescoping actuator and the lift bar actuator are connected such that as the telescoping actuator extends and retracts the conveyor, the lift bar actuator pivots the lift bar bracket about the bracket axis to substantially maintain the desired location.

11. The apparatus of claim 10 wherein the telescoping actuator and the lift bar actuator are provided respectively by a telescoping hydraulic cylinder and a lift bar hydraulic cylinder, and wherein when the telescoping hydraulic cylinder extends and retracts, hydraulic fluid flows between the telescoping hydraulic cylinder and the lift bar hydraulic cylinder to correspondingly extend and retract the lift bar hydraulic cylinder.

12. The apparatus of claim 1 comprising a support leg mounted to the frame in proximity to the pivot post, and a leg actuator operative to move the support leg from a raised transport position where a bottom end of the support leg is above the ground, to a lowered operating position where the bottom of the support leg bears against the ground to support the frame.

13. The apparatus of claim 1 further comprising an arm lateral actuator operative pivot the hoist arm laterally right and left about the vertical arm pivot axis.

14. A method of transferring agricultural products into product tanks mounted on a frame of an air seeder, the frame mounted on wheels for movement in an operating travel direction, the method comprising:
mounting a pivot post to the frame adjacent to the product tanks;
pivotally mounting a telescoping hoist arm on a top end of the pivot post about a substantially vertical arm pivot axis, and about a substantially horizontal arm pivot axis, with an arm lift actuator operative pivot the hoist arm up and down about the horizontal arm pivot axis;
pivotally mounting a hook member to an outside end of the hoist arm about a substantially vertical hook pivot axis and a substantially horizontal hook pivot axis;
supporting a conveyor on a conveyor rest in a transport position such that a longitudinal axis of the conveyor is substantially aligned with an operating travel direction of the air seeder, and the pivot post is between the conveyor and the product tanks;
mounting a lift bar to the conveyor above the conveyor and in proximity to a center of gravity of the conveyor;
where the agricultural products are transported in bulk in a transport vehicle, engaging the hook member with the lift bar about a substantially horizontal conveyor pivot axis oriented perpendicular to a longitudinal axis of the conveyor and activating the arm lift actuator to raise the conveyor above the conveyor rest and maneuvering the conveyor from the transport position to an operating position where the intake end thereof is on the ground and a discharge end thereof is oriented to discharge into one of the product tanks and directing agricultural products from the transport vehicle into the intake end of the conveyor and operating the conveyor to discharge the agricultural products into the one of the product tanks; and
where the agricultural products are transported in a bag, engaging the hook member with a bag tether to raise the bag above a desired one of the product tanks and draining the agricultural products from the bag into the desired one of the product tanks.
